(19) United States
(12) Patent Application Publication
(10) Pub. No.: US 2008/0243722 A1
(43) Pub. Date: Oct. 2, 2008

(54) Method and process for facilitating donations via debt instruments

(76) Inventor: Richard Nespola, New York, NY (US)

Correspondence Address: MAIER & MAIER, PLLC, 1000 DUKE STREET, ALEXANDRIA, VA, 22314, US

(21) Appl. No.: 11/984,451

(22) Filed: Nov. 19, 2007

Related U.S. Application Data
(60) Provisional application No. 60/907,345, filed on Mar. 29, 2007.

(51) Int. Cl. G06Q 40/00

(52) U.S. Cl. 705/36 T; 705/39

(57) ABSTRACT

A method, process and system for making charitable contributions according to at least one exemplary embodiment of the present invention can include having a debt contract entered into by a donative borrower and a lender acting as a donation conduit. The debt instrument can have a primary rate term and an borrower-elected donative rate term. The lender or a servicer, for example, owning the service rights can receive recurring payments from the donative borrower and directly or indirectly disburse the donations to one or more donees. In at least one embodiment, the donative borrower may also claim a first tax item based on the total interest paid on the debt contract over a time period as well as can claim a second tax item based on the total donations made over the same time period.

### CROSS REFERENCE TO RELATED APPLICATIONS

This application claims priority, under 35 U.S.C. § 119(e), to U.S. Provisional Patent Application Ser. No. 60/907,345, filed Mar. 29, 2007, the disclosure of which is incorporated by reference herein in its entirety.

### FIELD

The invention generally relates to the field of business practices for facilitating donations and more particularly to using debt instruments for facilitating donations.

### BACKGROUND

As the simplest form of philanthropic giving, donors provide selected charities with charitable contributions of cash, stock and/or equivalents such as appreciated real estate. These types of donations, from the standpoint of a donor, are easily facilitated and typically are based upon personal economic considerations, which determine the amount and timing of the donation. From a present tax perspective, donors receive the benefits at the Adjusted Gross Income (AGI) level as tax deductions. Gifts of securities are further advantageous from a tax planning perspective as the capital gains normally due on the sale of securities are eliminated when the securities are donated to a charity.

From the standpoint of recipient charities, direct donations are beneficial, like donations in general, nevertheless, there are several drawbacks associated with this form of giving. For example, donations can be quite unpredictable in regard to the amount contributed and the timing of contribution. In other words, such donations may not provide a predictable stream of income for the charities. Also, the donations are subject to the will of the donor, which can change, for example, from competition for limited funds among competing charities. Likewise, current events can impact donation levels because they can affect the ever changing priorities of donors. For example, unforeseen events that can be caused from, for example, natural disasters like the recent Pan-Asia Tsunami and Hurricane Katrina are likely to impact the priorities of some would-be donors.

Financial institutions do not benefit from donor directed charitable contributions. Although, financial institutions do benefit from other common methods of making charitable contributions such as donations made through charitable gift annuities.

As an alternative to direct contributions of cash, property, or marketable securities, donors can utilize a charitable gift annuity plan. A charitable gift annuity functions as a regularly established annuity payment program. Thus, in regard to charitable gift annuities, the insurance broker utilizes a designated charitable entity as the beneficiary of the annuity policy at mortality, with the charitable organization being designated as the responsible party for the annuity payments until mortality. This charitable giving structure may seem beneficial to all parties involved, but drawbacks do exist.

For donors, the program is advantageous because it provides a one time charitable deduction for the funding of the annuity. However, the income from the annuity is fully taxable. Moreover, such annuities are mostly utilized by elderly donors, which, in effect, limits the scope of participation from a wider array of donors resulting in a lesser benefit to participating charities than could otherwise be realized.

Although the prospects of attaining a large donation are promising for a charity, the administrative headache of managing the annuity is often time consuming and expensive. It also requires the charity to hold capital reserves against the annuity commitment to ensure annuity payments to the designees of the policies. The need to hold capital reserves limits investment opportunities as well as funding for charitable initiatives. It also limits funding to support the charity's constituents. Thus, the opportunity costs of holding reserves are high.

Financial institutions benefit from charitable gift annuities. Typically, an insurance company, acting as a broker in facilitating the charitable contribution, receives fees for origination and administration of the policy.

Charitable trusts can be created as part of another common method for facilitating charitable contributions. Charitable lead and remainder trusts are legal trust structures that are governed by federal tax law and the bylaws of the trust itself. These legal entities establish pools of equity that are managed, typically, by a wealth management firm (e.g., Goldman Sachs, Merrill Lynch, UBS, etc.) or an assigned individual. The investments donated to a trust are tax exempt under the shelter of the trust and the investment income is not taxed. Of course, the income must be donated to the chosen charities by the trust/foundation in accordance with the tax laws. All interest or gains on the sale of trust assets are subject to these provisions. Upon the mortality of the trustee(s), all of the investments are distributed per the trust instructions and are sheltered from estate taxes.

Overall, from a donor's perspective, charitable trusts are advantageous because donations are easily facilitated through the trust and the trust structure offers protection from estate taxes and income taxes. Additionally, the trust can also provide that the trustee(s) receive payment for their work in the form of a reasonable administrative fee.

The trust structure does have drawbacks such as required legal filings, which are often expensive. Administration fees for charitable trusts can also be expensive, especially, given the typical financial management requirements, annual filings and administrative fees. Also, a trust is required to have long run capital requirements in order to keep the trust in working order. Additionally, a trust's size, and therefore its income, is dependent upon the success of the investment portfolio. If the portfolio suffers losses, the charitable giving power is likewise reduced.

Charitable donations from trusts offer additional benefit to charities because, for example, the donations are not directly out-of-the-donor's-pocket and, thus, can require less effort to solicit. Nevertheless, as stated previously, the size of the donation is dependent upon the success of a trust's portfolio. Also, the timing of the distribution from the trust remains unpredictable for a charity. This is true for upfront donations made from trust income as well as trust distributions following mortality of the trustee(s).

Financial institutions benefit from trust structures. This is due to the return on equity for funds under management in the trust as well as the administrative income generated from filings and expenses plus margin and portfolio management fees, which are typically commensurate with the fund's performance.

Recent trends in charitable donations such as the (PRODUCT) RED™ campaign to help fight AIDS in Africa arguably symbolize a shift in the charitable giving mindset of people and businesses. The purchase of philanthropically marketed items from such campaigns represent an opportunity for consumers to express their desire to assist charities while receiving in return a physical indicator of their sentimentality through a branded product. This type of commercialized compassion is beneficial to charities, but is limited in its scale and scope of applicability.

Additionally, companies utilizing these campaigns as a marketing program receive the benefits of publicity and an image of public goodwill. However, the selection of supported charities is designated by the corporation; not the consumer. As such, the scope of interest by the consumer can be limited. Moreover, these arrangements do not permit the donor to benefit from potential tax deductibility for the portion contributed to charity; rather the participating companies can claim tax deductibility because they are making the charitable contributions as intermediaries for the facilitated donations. Likewise, many organizations have turned to utilizing charitable cause credit cards to facilitate charitable giving, which have similar drawbacks for donors/consumers.

These credit card programs typically function as a point accrual system, whereby a set number of points are earned by the consumer for purchases (typically on a ratio basis) and the points are converted by the credit card company into money. Then, the money is allocated to a charity/affiliate designated by the credit card company. Once again, the consumer does not receive the applicable tax deductibility benefit or the ability to designate charities.

The following patent publications illustrate and describe various background systems and methods. U.S. Publication No. 2007/0118470 (Warren et al.) relates to methods for allowing an account holder to easily customize the terms of an account such as a loan account, an asset account, a mortgage account, an insurance account, or a brokerage account. Exemplary embodiments of the invention allow the user to specify various preferred terms such as cost (e.g., APR and annual fee), rewards programs, card design, affiliates, credit line, and payment due date, among others. U.S. Publication No. 2007/0094112 (DePena) teaches a method for facilitating donations to a charitable organization wherein a financial transaction involving property is linked to a conditional pledge. A fundraising program facilitates the transactions which directly contribute to affiliated charitable organizations. U.S. Publication No. 2004/0162775 (Winklevoss et al.) teaches methods and systems for facilitating donor-directed asset management. In one embodiment, a program agreement may be established between a donor and a donee and an asset may be donated from the donor to the donee. The program agreement may specify, among other things, a period of time from investing the asset.

### SUMMARY

An embodiment of the present invention discloses a method of facilitating donations by a lender that can include executing a debt instrument with a donative borrower obliging the donative borrower to remit more than one payment to a servicer. The debt instrument can have a first rate term and a second rate term, and the recurring payment can have a principal portion, a first rate portion and a donative portion. The method can also include receiving the payment from the donative borrower and distributing the donative portion to one or more donee organizations. Alternatively, the donative portion can be distributed so as to fund a donative vehicle, which may be a trust in structure or the like known to one having ordinary skill in the art.

Another embodiment of the present invention discloses a method of facilitating donations by a lender that can include executing a debt instrument having a donation rate term and distributing a donation to one or more donee organizations.

Yet another embodiment of the present invention discloses a method of tax planning and reporting that can include entering into a debt contract with a lender. The debt contract can contract for more than one recurring payment where the recurring payment may have a total interest payment portion. The debt contract can provide for distributing a predetermined part of the total interest payment portion to one or more charitable organizations. The method can also include paying the recurring payments over a time period and claiming a first tax item based on a total interest paid on the debt contract over that time period as well as claiming a second tax item based on a total charitable contribution made over that time period to the one or more charitable organizations.

### BRIEF DESCRIPTION OF THE FIGURES

Advantages of embodiments of the present invention will be apparent from the following detailed description of the exemplary embodiments thereof, which description should be considered in conjunction with the accompanying drawings in which like numerals indicate like elements, in which:

FIG. 1 is a flowchart showing an exemplary method and process for donating via debt instruments.

FIG. 2 is another flowchart showing an exemplary method and process for donating via debt instruments.

FIG. 3 is yet another flowchart showing an exemplary method and process for donating via debt instruments.

FIG. 4 is an exemplary diagram showing a computer system.

### DETAILED DESCRIPTION

Aspects of the invention are disclosed in the following description and related drawings directed to specific embodiments of the invention. Alternate embodiments may be devised without departing from the spirit or the scope of the invention. Additionally, well-known elements of exemplary embodiments of the invention will not be described in detail or will be omitted so as not to obscure the relevant details of the invention. Further, to facilitate an understanding of the description, discussion of several terms used herein follows.

The word “exemplary” is used herein to mean “serving as an example, instance, or illustration.” Any embodiment described herein as “exemplary” is not necessarily to be construed as preferred or advantageous over other embodiments. Likewise, the term “embodiments of the invention” does not require that all embodiments of the invention include the discussed feature, advantage or mode of operation.

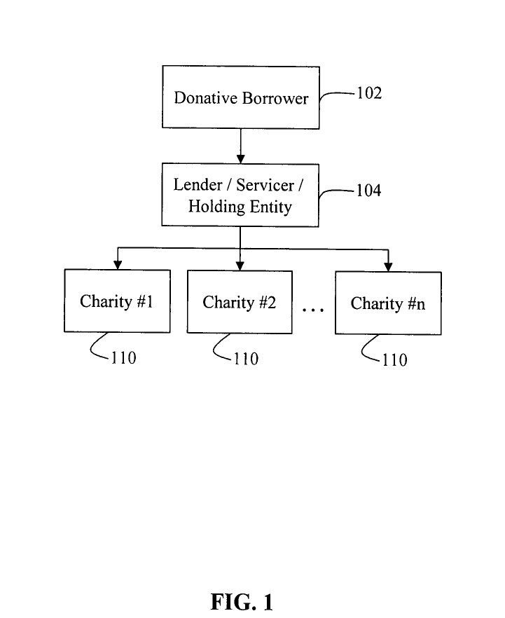

FIGS. 1-3 show processes for contributing donations to one or more donee organizations such as charitable organizations or other nonprofit organizations as well as for profit organizations in accordance with at least one exemplary embodiment of the present invention. Referring generally to FIGS. 1-3, one or more donative borrowers 102 and lender 104 can have an agreement embodied in a financial instrument such as a debt instrument. As one non-limiting example, the debt instrument can be a mortgage.

For ease of reference, without any intention of limiting embodiments thereto, exemplary embodiments are often described herein in reference to charitable organizations and debt instruments/contracts along with borrowing and lending parties thereto. Nevertheless, it will be understood that other organizations and entities that may not necessarily be primarily charitable in nature such as public and private colleges/universities, hospitals/clinics, political organizations, associations (e.g., trade associations), labor organizations, think tanks and any other entities that may accept donations are contemplated by embodiments of the present invention.

Also, in at least one exemplary embodiment, a donative borrower can elect to channel embedded benefit funds (corresponding to an elected donative interest rate increase) through a lender/servicer to a designated donative vehicle. This may provide donative borrowers with additional flexibility in choosing how donations are effectuated.

For example, the donative vehicle can be a charitable trust structure. In at least one exemplary embodiment, a charitable trust structure may benefit financial institutions by providing a greater return on equity (ROE) and/or a greater return on assets (ROA) via the trust holding greater trust assets under management. Also, donors may mitigate investment declines and corresponding reductions in donation capabilities by augmenting the income/assets of a trust with a dedicated stream of income. Trusts may be set up for general use (lead, remainder, etc.), scholarships and the like known to one having ordinary skill in the art. Further, as will be appreciated by those having skill in the art, donors may be able to set up various trusts associated with exemplary debt instruments in accordance with at least one embodiment of the present invention.

Moreover, although debt instruments such as mortgages are described herein in reference to exemplary embodiments, one of ordinary skill in the art will appreciate that various known financial instruments including instruments directed to equity as opposed to debt can be modified in accordance with embodiments of the inventions. Thus, the parties to such financial instruments can have a relationship that is different from a borrower/lender relationship. In fact, embodiments may enable various financial instruments to have the capacity to outline relationships that will function, at least in part, as donation conduits.

Additionally, other debt funding instruments besides mortgages, for example, including revolving debt loans (e.g., credit cards), automobile loans, educational loans (governmental, private, consolidation, etc.), private loans (whether or not secured), any other types of loans that may or may not grant a lien on an underlying asset and all other debt instruments known to one having ordinary skill in the art are contemplated for use with embodiments of the present invention. Also, all mortgage-type loans including second and any other successive mortgages taken against a property or taken against equity existing therein are contemplated. For example, embodiments may be applied to home equity lines of credit (HELOC); commonly categorized as a type of second mortgage.

An exemplary debt instrument can provide one or more donative borrowers 102 with the option to designate one or more charitable organizations 110, respectively, to be recipients of charitable contributions. As one non-limiting example, an addendum/rider can be added to each exemplary debt instrument that lists one or more charitable organizations 110 designated for charitable contributions. Alternatively, in at least one exemplary embodiment, one or more donative vehicles can be designated where the donative vehicle can benefit at least one charitable organization 110.

Still referring to FIGS. 1-3, each borrower 102 can also elect a donative rate increase, which can be considered a secondary rate that may be in addition to the primary rate that lender 104 may require as a condition of entering into, for example, each debt contract. The donative rate increase can be merged into the note/interest rate, which is often expressed as an annual percentage rate (APR) and the like, or, alternatively, for donative mortgages, can be attached to Mortgage Insurance Premiums that reside in escrow, which can be tax-deductible. Upon election, the rate increase can be incorporated into the primary rate, for example, expressed as the APR of the debt instrument, thus, providing one total APR, which may be fixed or variable depending on the terms of the debt instrument. For example, exemplary interest rate increases on a mortgage can be 0.125%, 0.250% and 0.375% APR increases. If, for example, the primary note rate is a 6.50% APR and borrower 102 elects a 0.250% APR increase, then the total note rate is the sum or a 6.75% APR (6.50%+0.25%=6.75%).

Once each borrower 102 fulfills any lending requirements and qualifications imposed by lender 104, the debt instrument can be executed. The debt contract can require recurring payments, which may become due periodically such as monthly payments.

Still referring to FIGS. 1-3, one or more donative borrowers 102 and lender 104 may have entered debt contracts with a borrower-elected interest rate increase that calls for recurring payments. Thus, each donative borrower 102 can remit a payment on the debt contract (in accords with the contractual obligations of each donative borrower 102) to lender 104 or, for example, to an entity that services the debt contract either because such entity bought the service rights for value from lender 104 or is acting on behalf of lender 104, both types of which and the like are referred to herein as a “servicer”.

Optionally, lender/servicer 104 can hold the borrower remittance for a period of time that can be designated in the financial instrument or any other agreement between lender 104 and donative borrowers 102 or by no agreement at all (e.g., as part of the ordinary business practices in the relevant industries). The lender/servicer 104 can profit from holding the capital for a period of time because, for example, the held capital can earn interest (or float) or otherwise be invested for profit over a short duration before being distributed to assigned recipients. Thus, embodiments may increase profits because the amount of held capital is increased and, in return, interest earned is increased thereon when a borrower remits a higher payment due to electing an interest rate increase for donative purposes.

Lender/servicer 104 may also pool capital from the remittances of numerous donative borrowers 102 and any other capital sources (e.g., non-donative borrowers) known to one having ordinary skill in the art. Aggregating or pooling capital can be used to increase transaction volume, which may increase profits by, for example, decreasing transaction and administrative costs.

For example, Table 1 below is illustrative of the additional held capital available to lender/servicer 104 for earning interest or otherwise investing over a short duration. Entries are calculated based on a mortgage pool in the amount of $100,263,500 (e.g., 400 loans with an average unpaid balance of $250,658.75) where all mortgages are 30 year conforming mortgages with a primary APR of 6.375% and elected donative interest rate increase of 0.250%. Thus, the total APR is 6.625%.

TABLE 1

| | Annual | Additional |
|---|---|---|
| | Remittance | Remittance |
| Conventional | $6,358,654 | N/A |
| Mortgage | | |
| Donative | $6,608,013 | $249,359 |
| Mortgage | | |

As illustrated by Table 1, an additional remittance of $249,359 is available to lender/servicer 104 due to the elected donative interest rate as compared to a similar pool of conventional mortgages.

Lender/servicer 104 may be responsible for recording various types of financial information such as the principal portion of payments, primary interest, secondary interest, total interest and other payment information known to one having ordinary skill in the art. Lender/servicer 104 may also generate reports and statements that can be delivered to the one or more borrowers 102 for tax planning and reporting purposes, particularly, for any tax benefits related to interest paid on a debt instrument and to charitable contributions made by each donative borrower 102.

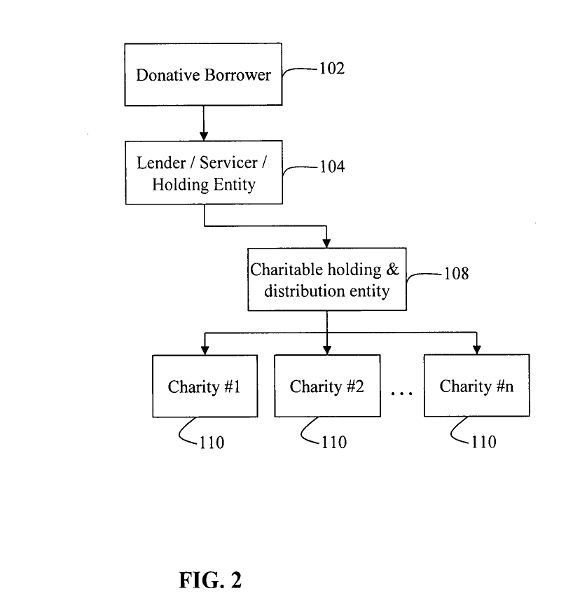

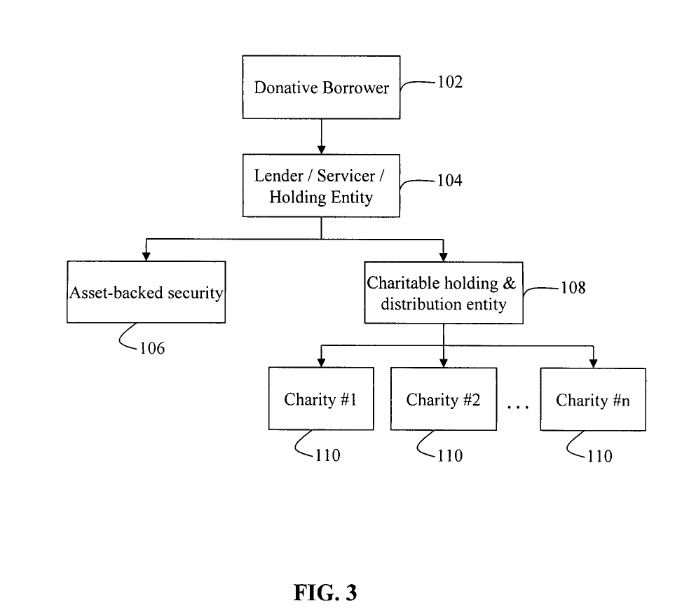

Still referring to FIGS. 1-3, the total remittance of each borrower 102 can be divided and distributed to applicable parties. Lender/servicer 104 can distribute, whether through one or more intermediaries 108 (see FIGS. 2 and 3) or not (see FIG. 1), a portion of the remittance to one or more charitable organizations 110. The portion distributed to the one or more charities 110 can be that portion—the donative portion—of the payment from each borrower 102 that is earmarked to pay on the elected interest rate increase or can be any further division of such donative portion. Each donative portion, which may be aggregated, can be distributed among one or more charitable organizations 110 in equal or unequal amounts, for example, according to the instructions of each donative borrower 102 that may be contained in (e.g., appended and incorporated into) the terms of each debt instrument.

Referring specifically to FIG. 1, lender/servicer 104 can directly disburse each donative portion, which may be aggregated donative portions from a plurality of donative borrowers 102, earmarked for charitable contribution to the one or more charitable organizations 110 in accordance with the instructions of each donative borrower 104, if any.

Alternatively, singularly or in conjunction, as shown in FIGS. 2 and 3, lender/servicer 104 can disburse each donative portion, which may be aggregated, to one or more intermediaries 108 such as a charitable holding and distribution entity that, for example, may be formed to specifically handle such disbursements. Like lender/servicer 104, intermediary 108 can hold the capital for a period of time (float) that may be designated and pool capital, for example, from multiple lenders/services 104 in order to earn interest or otherwise invest the held capital for profit. Also, intermediary 108 can disburse the charitable funds to one or more charitable organizations 110 in accordance with instructions of each donative borrower 104, if any, that may be included within each debt instrument or otherwise provided for.

Intermediary 108 can be made responsible for recording the charitable contributions from the one or more donative borrowers 102 and any other relevant information known to one having ordinary skill in the art. Lender/servicer 104 may also generate reports and statements that can be delivered to the one or more borrowers 102 for tax planning and reporting purposes, particularly, for determining any tax benefits related to the charitable contributions of each borrower 102.

Referring to FIG. 3, lender/servicer 104 can distribute the aggregated non-donative portion, which may be the principal portion and the interest portion due on the first interest rate term of each debt instrument, to an underlying security such as asset-backed security (ABS) 106 based upon the debt obligation instructions of ABS 106. For instance, ABS 106 may be a mortgage-backed security (MBS) corresponding to an exemplary mortgage product as is known to those having ordinary skill in the art. Further, as will be appreciated by one having ordinary skill in the art, a MBS may require that all or some of the disbursement is held in trust (e.g., escrow) until the appropriate conditions are met.

Accordingly, the exemplary processes of FIGS. 1-3 can each be repeated in relation to each borrower and each debt contract entered into therewith until a debt instrument is satisfied, refinanced or terminated.

Tables 2a and 2b below illustrate, by way of examples, how at least one exemplary embodiment of the present invention may be financially attractive to a donative borrower from a tax planning and reporting standpoint because donative payment portions may be eligible for double tax-deductibility status.

TABLE 2a

| | | Primary | | | | | | | | |
|---|---|---|---|---|---|---|---|---|---|---|
| Year | Donation | INT | Total INT | CTD | MTD | Total MTD | Total TD | ADV | Old Cost | New Cost |
| 1 | $746.02 | $18,650.43 | $19,396.45 | $208.88 | $5,222.12 | $5,431.01 | $5,639.89 | $417.77 | $537.13 | $328.25 |
| 2 | $736.97 | $18,424.32 | $19,161.29 | $206.35 | $5,158.81 | $5,365.16 | $5,571.51 | $412.70 | $530.62 | $324.27 |
| 3 | $727.35 | $18,183.66 | $18,911.00 | $203.66 | $5,091.42 | $5,295.08 | $5,498.74 | $407.31 | $523.69 | $320.03 |
| 4 | $717.10 | $17,927.52 | $18,644.62 | $200.79 | $5,019.70 | $5,220.49 | $5,421.28 | $401.58 | $516.31 | $315.52 |
| 5 | $706.20 | $17,654.90 | $18,361.10 | $197.73 | $4,943.37 | $5,141.11 | $5,338.84 | $395.47 | $508.46 | $310.73 |
| Total | $3,633.64 | $90,840.83 | $94,474.46 | $1,017.41 | $25,435.42 | $26,452.85 | $27,470.26 | $2,034.83 | $2,616.21 | $1,598.80 |
| Sav- | | | | | | | | | | $1,017.41 |
| ings | | | | | | | | | | |

TABLE 2b

| Year | Donation | Primary INT | Total INT | CTD | MTD | Total MTD | Tot. TD | ADV | Old Cost | New Cost |
|---|---|---|---|---|---|---|---|---|---|---|
| 1 | $1,616.77 | $42,036.09 | $43,652.86 | $533.53 | $13,871.91 | $14,405.44 | $14,938.98 | $1,067.07 | $1,083.24 | $549.70 |
| 2 | $1,598.06 | $41,549.53 | $43,147.58 | $527.36 | $13,711.34 | $14,238.70 | $14,766.06 | $1,054.72 | $1,070.70 | $543.34 |
| 3 | $1,578.09 | $41,030.37 | $42,608.47 | $520.77 | $13,540.02 | $14,060.79 | $14,581.56 | $1,041.54 | $1,057.32 | $536.55 |
| 4 | $1,556.79 | $40,476.45 | $42,033.24 | $513.74 | $13,357.23 | $13,870.97 | $14,384.71 | $1,027.48 | $1,043.05 | $529.31 |
| 5 | $1,534.06 | $39,885.44 | $41,419.49 | $506.24 | $13,162.19 | $13,668.43 | $14,174.67 | $1,012.48 | $1,027.82 | $521.58 |
| Total | $7,883.77 | $204,977.88 | $212,861.64 | $2,601.64 | $67,642.69 | $70,244.33 | $72,845.98 | $5,203.29 | $5,282.13 | $2,680.48 |
| Sav- | | | | | | | | | | $2,601.65 |
| ings | | | | | | | | | | |

Remembering that the extent of the tax-deductible benefit conferred for the tax items claimed, if any, by a donative borrower in accordance with at least one exemplary embodiment are likely to be dependent on the legal interpretation of such claimed benefits by a tax collection agency such as the Internal Revenue Service (IRS).

In calculating the exemplary entries contained in Table 2a, an exemplary donative borrower is party to a fixed rate conforming mortgage for $300,000 with a primary APR of 6.25% and an elected secondary APR of 0.25% in accordance with at least one exemplary embodiment of the present invention. Accordingly, the total APR is 6.50% (6.25%+0.25%=6.50%). Here, payment portions directed to the secondary interest are designated and delivered, in full, to one or more charitable organizations. Also, for tax deductibility purposes and calculations in Table 2a, the adjusted gross income (AGI) is taxed at a rate of 28%.

Similarly, in calculating the exemplary entries contained in Table 2b, an exemplary donative borrower is party to a fix rate non-conforming mortgage (as defined by the guidelines of the FNMA/FHLMC, commonly referred to as Fannie Mae and Freddie Mac,) for $650,000 with a primary APR of 6.50% and an elected secondary APR of 0.25%, thus, the total APR is 6.75% (6.50%+0.25%=6.75%). Payment portion directed to the secondary interest rate are also designated and delivered, in full, to one or more charitable organizations. For tax deductibility purposes and calculations in Table 2b, the adjusted gross income tax rate is 33%.

Furthermore, as a courtesy to a reader of this disclosure, please note that depending on how entries are calculated in Tables 2a and 2b, some entries may appear to be off by one cent because, in part, of the common practice of rounding up or down to the nearest cent.

Tables 2a and 2b are directed to years one through five as shown in the “Year” column as well as the five year total for each other column on the respective tables. “Donation” column shows the yearly total of charitable contributions, which equals, in this example, the yearly total of payment portions in accordance with the elected donative interest rate (expressed as a 0.25% APR). “Primary INT” column shows the yearly total of payment portions in accordance with the primary interest rate. Where “Total INT” column is the sum of yearly total of payments portions in accordance with the primary and secondary interest rates or, in other words, is the yearly total of payment portions in accordance with the total note rate without accounting for the principal portion.

“CTD” or “Charitable Tax Deductibility savings” column shows the tax savings earned per year on taking a charitable contribution tax deduction of the amount expressed in the corresponding “Donation” column. As may be noted here, tax deductions do not grant savings on a dollar-by-dollar basis, but rather can adjust taxable income downward to expose less income to taxation subject to the tax laws. Assuming, as done in Table 2a, a 28% tax rate is applied, thus, “CTD” column shows the tax savings of taking a deduction of the amount shown in corresponding year's “Donation” column against a donative borrower's taxable income (e.g., 28% of $746.02 equals $208.88). Likewise, “MTD” or “Mortgage interest Tax Deductibility savings” column expresses a similar calculated entry for tax savings on the yearly total of payment portions directed to the primary interest rate when the yearly interest paid on the primary rate is claimed as a tax-deductible expense (e.g., 28% of $18,650.43 equals $5,222.12).

“Total MTD” or “Total Mortgage interest Tax Deductibility savings” column expresses the yearly tax savings on the yearly total of mortgage interest payments directed to the total note rate including interest paid in accordance with the primary and secondary (i.e. elected donative) note rate. According to at least one exemplary embodiment of the present invention, a tax benefit can be claimed on the total interest paid on a donative mortgage even though a portion of the interest paid is designated for later contribution to one or more charitable organizations, for example, without affecting the donative borrower's ability to claim a charitable contribution tax benefit.

Still referring to Tables 2a and 2b, “Total TD” or “Total Tax Deductibility savings” column expresses the yearly tax savings including both the CTD and MTD on the total interest paid in accordance with the total note rate. Notably, interest paid in accordance with the elected interest rate can be claimed twice. Once, as a charitable contribution tax item such as a tax-deductible expense and claimed again as part of a tax item such as a tax-deductible expense on the total mortgage interest paid in accordance with the total note rate. Thus, embodiments of the present invention may provide double tax-deductibility status to donations such as charitable contributions.

“ADV” or “cost Advantage” column is directed to such a double tax-deductibility status where the total charitable contribution is claimed twice and thus twofold the CTD separates the “Total TD” and the “MTD”. This difference is expressed in the “ADV” column and can illustrate an “advantage” of the donative mortgage as compared to conventional mortgages known to one having ordinary skill in the art.

“Old cost” column expresses the cost of conventional tax-deductible charitable contributions for the corresponding amount contributed as shown in the “Donation” column. Simply put, the cost of conventional tax-deductible charitable contributions is the amount of the donation subtracted by the tax savings conferred by the tax benefit claimed (and received). As such, the cost of the conventional tax-deductible charitable contribution as illustrated in Tables 2a and 2b is the entries in the “Donation” column subtracted by the corresponding entries in the “CTD” column.

According to at least one exemplary embodiment of the present invention, the “New Cost” column expresses the cost of double tax-deductible charitable contributions for the corresponding amount contributed as shown in the “Donation” column. Here, the cost is the entries in the “Donation” column subtracted by the corresponding entries in the “ADV” column (or subtracted by twice the “CTD”). In at least one embodiment of the present invention, the cost of tax-deductible charitable contributions is decreased as compared (e.g. by a factor of the amount of the “CTD”) to conventional tax-deductible contributions because of the double tax-deductibility status that may be claimed with a tax agency such as the IRS.

Thus, as shown in Tables 2a and 2b, a total charitable costs savings of $1,017.41 and $2601.65, respectively, can be achieved by our exemplary donative borrowers over the first five years of the above-described exemplary donative mortgages.

Generally, embodiments of the present invention may allow any financed purchase to serve as a donation conduit. Exemplary embodiments may include, for instance, a debt instrument such as a mortgage product having a borrower-elected interest rate benefit directed to a borrower-designated donee organization.

Embodiments of the present invention may increase donations to organizations by potentially benefiting all stakeholders across the donative value chain (e.g., donors, donee organizations and financial institutions). Thus, embodiments of the present invention may achieve one or more of the following benefits through the use of an embedded benefit plan established in a financial product that differs from donations presently made through, for example, conventional credit card products. Moreover, in general, embodiments can provide various benefits as compared to conventional donation methods as will be appreciated by one having ordinary skill in the art.

By providing an electable, donative interest rate increase embodied within a mortgage product, at least one embodiment of the present invention can leverage economies of scale present within and throughout the mortgage industry. This is particularly beneficial in that the economies of scale available through the mortgage industry are considerable. According to some estimates, $2.4 trillion in loan originations were represented in 2004, which is indicative of the economies of scale present. Thus, due to the size of the industry, embodiments of the present invention can take advantage of the high transaction volumes, inter alia, in order to materially benefit charitable organizations. In contrast, such economies of scale are not currently being leverage and unlikely to be available to conventional donation methods.

It can be noted here that greater unpaid balances (UPB) item such as mortgage loan balances, car loan balances and the like can facilitate greater donation amounts to donee organizations as compared to utilizing lesser UPB such as credit card balances provide an additional benefit in that they can enable larger, sustainable giving practices.

Increased consumer choice in regard to designating donee organizations is another benefit that can increase the likelihood that embodiments of the present invention will be accepted and successful within the marketplace. Unlike many conventional donation methods where a corporation or other sponsor chooses which (partners with) charitable organizations are to receive donations, embodiments of the present invention can be practiced so as to allow the borrower to choose any donee organization whether they have a relationship with (or even known to) the lender or not.

For example, conventional credit card products only allow a consumer to choose one organization out of the total number of organizations that they have designated (partnered with). Similarly, charitable campaigns such as (PRODUCT) RED™ are directed to particular causes or a group of related causes. However, embodiments of the present invention can allow a donative borrower to designate a donee organization (or more than one) to contribute to. For example, this may be achieved by attaching an addendum such as a rider to a mortgage product according to at least one exemplary embodiment of the present invention.

Moreover, consumer's can choose their level of support because embodiments of the present invention can provide for selecting a donative interest rate according to their desired level of contribution. In at least one embodiment, this can be accomplished by providing multiple electable interest rate options to a donative borrower where the donative borrower can select one. Thus, consumers are not beholden to one spend-to-support ratio mechanism (e.g., percentage of purchase, point per dollar spent, etc.) such as now offered in association with conventional credit card products as well as by conventional charitable campaigns.

Further, because embodiments of the present invention do not rely on spend-to-support ratio mechanisms, contribution amounts can have increased predictability and, therefore, provide a predictable stream of income to donee organizations. Predictability is increased because the donation amount corresponds to the elected interest rate and is in accordance with the terms of the financial product, which are established between the lender and borrower early-on in the donative lifecycle (i.e., during execution of the donative, financial instrument). Of course, predictability can be subject to, inter alia, consistency of payment and the presence of an unpaid balance.

Increased predictability is particularly beneficial to donee organizations because organizations can obtain projections of cash flow based upon expected assets from embodiments of the present invention and, thus, establish a financial plan according to the predicted stream of income. This is unlike various conventional donation methods where predictability can be significantly decreased due to a variety of factors including irregular donations, irregular purchases tied to a donative spend-to-support ratio mechanism, performance of assets under management and others factors known to one having ordinary skill in the art.

Donee organizations may also benefit from having limited set up and administrative costs in both the short term and long term. A further benefit may be to limit a donor's out-of-pocket-expense perceptions because donations are tied to a financial product that can primarily be for non-charitable purpose, thus, potentially increasing donations to donee organizations.

Borrowers may benefit from the potential double tax-deductibility status described above in conjunction with Tables 2a and 2b. In relation to this aspect, borrowers can further benefit according to at least one exemplary embodiment because they can also be provided with reports and statements for tax reporting purposes from the lender and/or servicer as well as any intermediary (also described above). These benefits to the customer are in direct opposition to conventional donation methods where the sponsor (e.g., a credit card company) receives the tax benefits.

Financial institutions, for example, those in the mortgage industry can benefit from offering or being associated with a product that can appeal to customers of a charitable mindset, particularly, because of the flexibility in of choosing donation recipients that embodiments of the present invention can offer. Thus, financial institutions can increase competitiveness within their market and potentially increase their market share. Lenders, servicers and/or intermediaries can also increase revenues as described above in regard to increasing held capital. Lenders can also benefit because of secondary market execution through an ABS such as a MBS in order to produce liquidity for the lenders issuing these securities, which is often needed to raise additional funds to make additional loans. These additional loans can further increase the benefits to all stakeholders.

Additionally, financial institutions may increase customer retention utilizing financial products having a borrower-elected benefit to a borrower-designated donee organization because borrowers are likely to desire participating in a similar program when considering other debt instruments. For example, participating borrowers are likely to desire a similar program when they consider options for refinancing or taking a second mortgage out. Moreover, borrowers may want to both finance an additional purchase and increase their level of charitable contribution through executing a new debt instrument in accordance with at least one exemplary embodiment of the present invention.

Without any intent to characterize the background references cited above, embodiments of the present invention are believed to differ materially and provide one or more benefits over such references to stakeholders. For example, the Warren reference provides an account holder with the opportunity to modify the terms of an account, but is not believed to differ materially from conventional donation methods such as charitable credit cards programs in regard to the donation facilitating aspects of such methods.

Also like some conventional donation facilitating methods, the DePena reference teaches using affiliated charitable organizations. However, exemplary embodiments of the present invention can allow borrowers to select the charitable organizations, which may be one significant benefit, among others.

The Winklevoss reference teaches establishing a donation agreement between a donor and a donee that may specify, inter alia, a period of time for investing the asset. Nevertheless, as one notably difference among others, the Winklevoss reference is not believed to teach or suggest using an established financial product such as a mortgage product as a donation conduit. The use of established financial products as donation conduits may provide one or more benefits to stakeholders across the donative value chain of exemplary embodiments as described above.

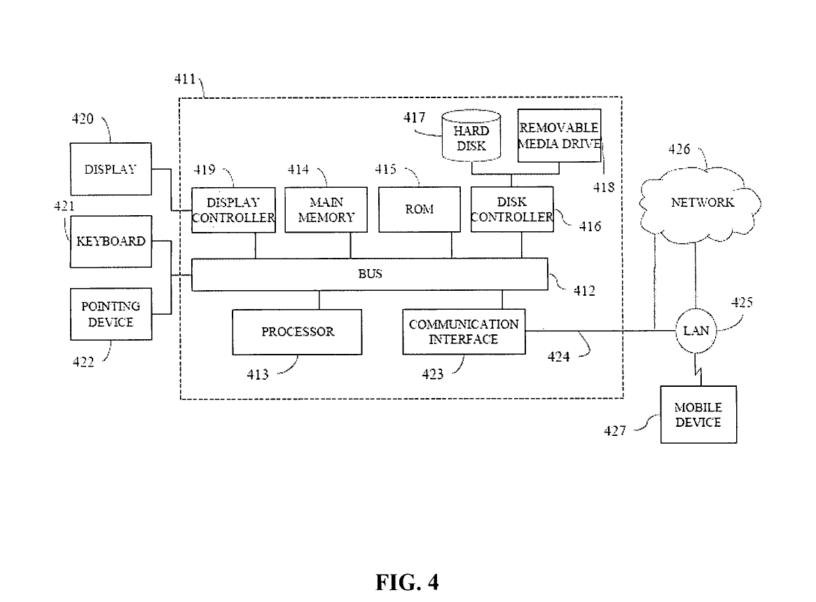

FIG. 4 illustrates a computer system 411 upon which an embodiment of the present invention may be implemented. The computer system 411 includes a bus 412 or other communication mechanism for communicating information, and a processor 413 coupled with the bus 412 for processing the information. The computer system 411 also includes a main memory 414, such as a random access memory (RAM) or other dynamic storage device (e.g., dynamic RAM (DRAM), static RAM (SRAM), and synchronous DRAM (SDRAM)), coupled to the bus 412 for storing information and instructions to be executed by processor 413. In addition, the main memory 414 may be used for storing temporary variables or other intermediate information during the execution of instructions by the processor 413. The computer system 411 further includes a read only memory (ROM) 415 or other static storage device (e.g., programmable ROM (PROM), erasable PROM (EPROM), and electrically erasable PROM (EEPROM)) coupled to the bus 412 for storing static information and instructions for the processor 413.

The computer system 411 also includes a disk controller 416 coupled to the bus 412 to control one or more storage devices for storing information and instructions, such as a magnetic hard disk 417, and a removable media drive 418 (e.g., floppy disk drive, read-only compact disc drive, read/write compact disc drive, compact disc jukebox, tape drive, and removable magneto-optical drive). The storage devices may be added to the computer system 411 using an appropriate device interface (e.g., small computer system interface (SCSI), integrated device electronics (IDE), enhanced-IDE (E-IDE), direct memory access (DMA), or ultra-DMA).

Further, exemplary embodiments include or incorporate at least one database which may store software, descriptive data, system data, digital images and any other data item required by the other components necessary to effectuate any embodiment of the present system and method known to one having ordinary skill in the art. The databases may be provided, for example, as a database management system (DBMS), a relational database management system (e.g., DB2, ACCESS, etc.), an object-oriented database management system (ODBMS), a file system or another conventional database package as a few non-limiting examples. The databases can be accessed via a Structure Query Language (SQL) or other tools known to one having skill in the art.

Still referring to FIG. 4, the computer system 411 may also include special purpose logic devices (e.g., application specific integrated circuits (ASICs)) or configurable logic devices (e.g., simple programmable logic devices (SPLDs), complex programmable logic devices (CPLDs), and field programmable gate arrays (FPGAs)).

The computer system 411 may also include a display controller 419 coupled to the bus 412 to control a display 420, such as a cathode ray tube (CRT), liquid crystal display (LCD) or any other type of display, for displaying information to a computer user. The computer system may include input devices, such as a keyboard 421 and a pointing device 422, for interacting with a computer user and providing information to the processor 413. Additionally, a touch screen could be employed in conjunction with display 420. The pointing device 422, for example, may be a mouse, a trackball, or a pointing stick for communicating direction information and command selections to the processor 413 and for controlling cursor movement on the display 420. In addition, a printer may provide printed listings of data stored and/or generated by the computer system 411.

The computer system 411 performs a portion or all of the processing steps of the invention in response to the processor 413 executing one or more sequences of one or more instructions contained in a memory, such as the main memory 414. Such instructions may be read into the main memory 414 from another computer readable medium, such as a hard disk 417 or a removable media drive 418. One or more processors in a multi-processing arrangement may also be employed to execute the sequences of instructions contained in main memory 414. In alternative embodiments, hard-wired circuitry may be used in place of or in combination with software instructions. Thus, embodiments are not limited to any specific combination of hardware circuitry and software.

As stated above, the computer system 411 includes at least one computer readable medium or memory for holding instructions programmed according to the teachings of the invention and for containing data structures, tables, records, or other data described herein. Examples of computer readable media are compact discs, hard disks, floppy disks, tape, magneto-optical disks, PROMs (EPROM, EEPROM, flash EPROM), DRAM, SRAM, SDRAM, or any other magnetic medium, compact discs (e.g., CD-ROM), or any other optical medium, punch cards, paper tape, or other physical medium with patterns of holes, a carrier wave (described below), or any other medium from which a computer can read.

Stored on any one or on a combination of computer readable media, the present invention includes software for controlling the computer system 411, for driving a device or devices for implementing the invention, and for enabling the computer system 411 to interact with a human user. Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpretable or executable code mechanism, including but not limited to scripts, interpretable programs, dynamic link libraries (DLLs), Java classes, and complete executable programs. Moreover, parts of the processing of the present invention may be distributed for better performance, reliability, and/or cost.

The term “computer readable medium” as used herein refers to any medium that participates in providing instructions to the processor 413 for execution. A computer readable medium may take many forms, including but not limited to, non-volatile media, volatile media, and transmission media. Non-volatile media includes, for example, optical, magnetic disks, and magneto-optical disks, such as the hard disk 417 or the removable media drive 418. Volatile media includes dynamic memory, such as the main memory 414. Transmission media includes coaxial cables, copper wire and fiber optics, including the wires that make up the bus 412. Transmission media also may also take the form of acoustic or light waves, such as those generated during radio wave and infrared data communications.

Various forms of computer readable media may be involved in carrying out one or more sequences of one or more instructions to processor 413 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to the computer system 411 may receive the data on the telephone line and use an infrared transmitter to convert the data to an infrared signal. An infrared detector coupled to the bus 412 can receive the data carried in the infrared signal and place the data on the bus 412. The bus 412 carries the data to the main memory 414, from which the processor 413 retrieves and executes the instructions. The instructions received by the main memory 414 may optionally be stored on storage device 417 or 418 either before or after execution by processor 413.

The computer system 411 also includes a communication interface 423 coupled to the bus 412. The communication interface 423 provides a two-way data communication coupling to a network link 424 that is connected to, for example, a local area network (LAN) 425, or to another communications network 426 such as the Internet. For example, the communication interface 423 may be a network interface card to attach to any packet switched LAN. As another example, the communication interface 423 may be an asymmetrical digital subscriber line (ADSL) card, an integrated services digital network (ISDN) card or a modem to provide a data communication connection to a corresponding type of communications line. Wireless links may also be implemented. In any such implementation, the communication interface 423 sends and receives electrical, electromagnetic or optical signals that carry digital data streams representing various types of information.

The network link 424 typically provides data communication through one or more networks to other data devices. For example, the network link 424 may provide a connection to another computer or remotely located presentation device through a local network 425 (e.g., a LAN) or through equipment operated by a service provider, which provides communication services through a communications network 426. In preferred embodiments, the local network 424 and the communications network 426 preferably use electrical, electromagnetic, or optical signals that carry digital data streams. The signals through the various networks and the signals on the network link 424 and through the communication interface 423, which carry the digital data to and from the computer system 411, are exemplary forms of carrier waves transporting the information. The computer system 411 can transmit and receive data, including program code, through the network(s) 425 and 426, the network link 424 and the communication interface 423. Moreover, the network link 424 may provide a connection through a LAN 425 to a mobile device 427 such as a personal digital assistant (PDA) laptop computer, or cellular telephone. The LAN communications network 425 and the communications network 426 both use electrical, electromagnetic or optical signals that carry digital data streams. The signals through the various networks and the signals on the network link 424 and through the communication interface 423, which carry the digital data to and from the system 411, are exemplary forms of carrier waves transporting the information. The processor system 411 can transmit notifications and receive data, including program code, through the network(s), the network link 424 and the communication interface 423.

Other aspects of the invention may include data transmission and Internet-related activities. See Preston Gralla, How the Internet Works, Ziff-Davis Press (1996), which is hereby incorporated by reference into this patent application. Still other aspects of the invention may utilize wireless data transmission, such as those described in U.S. Pat. Nos. 6,456,645, 5,818,328 and/or 6,208,445, all of which are hereby incorporated by reference into this patent application.

The foregoing description and accompanying drawings illustrate the principles, preferred embodiments and modes of operation of the invention. However, the invention should not be construed as being limited to the particular embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

What is claimed is:

1. A method of facilitating donations by a lender comprising:
executing a debt instrument with a donative borrower obliging the donative borrower to remit more than one payment to a servicer, the debt instrument having a first rate term and a second rate term, wherein the payment is characterized by a principal portion, a first rate portion and a donative portion;
receiving the payment from the donative borrower; and
distributing the donative portion to one or more donee organizations.

2. The method of claim 1 wherein the servicer is the lender.

3. The method of claim 1 wherein the servicer owns a service right.

4. The method of claim 1 further comprising:
distributing the donative portion to an intermediary for distribution to the one or more donee organizations.

5. The method of claim 4 wherein the intermediary is a holding fund company.

6. The method of claim 4 wherein the intermediary holds the donative portion for a period of time as part of a pool of capital, wherein the pool of capital earns interest.

7. The method of claim 1 wherein the debt instrument is a mortgage.

8. The method of claim 1 wherein the donative borrower chooses the one or more donee organizations.

9. The method of claim 8 wherein the donative borrower's choice of the one or more donee organizations is contained in an addendum to the debt instrument.

10. The method of claim 1 wherein the second rate term is one or more electable rate terms electable by the donative borrower.

11. The method of claim 1 further comprising:
holding the payment for a period of time as part of a pool of capital, wherein the pool of capital earns interest.

12. The method of claim 1 further comprising:
distributing, at least in part, the principal portion and the first rate portion to a security in accordance with one or more debt instructions.

13. The method of claim 1 further comprising:
repeating the steps of receiving the payment and distributing the donative portion until the debt contract is one of satisfied, refinanced and terminated.

14. The method of claim 1 wherein the one or more donee organizations is at least one charitable organization.

15. The method of claim 1 wherein the debt instrument is one of an automobile loan, a credit card loan, an educational loan and a private loan.

16. A method of facilitating charitable donations by a lender comprising:
a means for executing a debt instrument having a donation rate term; and
a means for distributing a donation to one or more donee organizations.

17. A method of funding a donative vehicle comprising:
executing a debt instrument with a donative borrower obliging the donative borrower to remit more than one payment to a servicer, the debt instrument having a first rate term and a second rate term, wherein the payment is characterized by a principal portion, a first rate portion and a donative portion;
receiving the payment from the donative borrower; and
funding a donative vehicle with the donative portion.

18. The method of claim 17 wherein the donative vehicle is a trust.

19. The method of claim 18 wherein the trust has a donee organization as a beneficiary.

20. The method of claim 18 wherein the trust is a charitable trust.

21. A method of tax planning and reporting comprising:
entering into a debt contract with a lender, the debt contract contracting for more than one recurring payment, the recurring payment having an total interest payment portion, wherein the debt contract provides for distributing a predetermined part of the total interest payment portion to one or more charitable organizations;
paying the recurring payments over a time period;
claiming a first tax item based on a total interest paid on the debt contract over the time period;
claiming a second tax item based on a total charitable contribution made over the time period to the one or more charitable organizations.

22. The method of claim 21 wherein the debt contract is a mortgage.

23. The method of claim 21 wherein the first tax item and the second tax item are a first tax-deductible expense and a second tax-deductible expense.

24. The method of claim 21 wherein the debt contract has a primary rate term and a secondary rate term, wherein the secondary rate term is independently electable.
